(19) United States
(12) Patent Application Publication
(10) Pub. No.: US 2026/0193031 A1
(43) Pub. Date: Jul. 9, 2026

(54) ELECTRIC REAR-LOADING REFUSE VEHICLE

(71) Applicant: Oshkosh Corporation, Oshkosh, WI (US)

(72) Inventors: Jeff Verhagen, Oshkosh, WI (US); Aaron Fisher, Oshkosh, WI (US); Greg Steffens, Oshkosh, WI (US)

(21) Appl. No.: 19/439,220

(22) Filed: Jan. 2, 2026

Related U.S. Application Data
(60) Provisional application No. 63/741,646, filed on Jan. 3, 2025.

(51) Int. Cl. B65F 3/02; B65F 3/20

(52) U.S. Cl. CPC B65F 3/02; B65F 3/20; B65F 2003/0263

(57) ABSTRACT

An electric rear-loading refuse vehicle includes a chassis and a cab coupled to a front end of the chassis. The electric rear-loading refuse vehicle further includes a rear-loading body assembly coupled to the chassis and positioned behind the cab. The rear-loading body assembly includes a refuse compartment including a hopper volume and a storage volume, and a packing actuator configured to compact refuse from the hopper volume into the storage volume. The electric rear-loading refuse vehicle further includes an electric energy storage device coupled to the chassis, and an electric drive motor coupled to the chassis and electrically connected to the electric energy storage device for driving the electric rear-loading refuse vehicle. The electric rear-loading refuse vehicle further includes a cowl assembly coupled to the electric rear-loading refuse vehicle and an electric power take off (EPTO) pod removably coupled to the cab and positioned within the cowl assembly.

### CROSS-REFERENCE TO RELATED APPLICATIONS

This application claims the benefit of and priority to U.S. Provisional Patent Application No. 63/741,646, filed Jan. 3, 2025, the entire contents of which are hereby incorporated by reference herein.

### BACKGROUND

The present disclosure relates generally to the field of refuse vehicles and, in particular, electrically powered refuse vehicles.

### SUMMARY

One embodiment relates to an electric rear-loading refuse vehicle including a chassis and a cab coupled to a front end of the chassis. The electric rear-loading refuse vehicle further includes a rear-loading body assembly coupled to the chassis and positioned behind the cab. The rear-loading body assembly includes a refuse compartment including a hopper volume and a storage volume, and a packing actuator configured to compact refuse from the hopper volume into the storage volume. The electric rear-loading refuse vehicle further includes an electric energy storage device coupled to the chassis, and an electric drive motor coupled to the chassis and electrically connected to the electric energy storage device for driving the electric rear-loading refuse vehicle. The electric rear-loading refuse vehicle further includes a cowl assembly including a front shroud coupled to the cab and a rear shroud positioned at least partially behind the front shroud, and an electric power take off (EPTO) pod removably coupled to the cab and positioned within the cowl assembly. The EPTO pod includes a reservoir of hydraulic fluid, an inverter electrically coupled to the electric energy storage device, an electric motor electrically coupled to the inverter, and a pump coupled to the motor and configured to pump hydraulic fluid from the reservoir to the packing actuator.

In some embodiments, the EPTO pod is coupled to a roof of the cab and positioned within the rear shroud. In some embodiments, the rear-loading refuse vehicle further includes a cooling assembly positioned within the cowl assembly. In some embodiments, the EPTO pod is configured for the cooling assembly to rotate rearward and past a front edge of the EPTO pod from a use position to a maintenance position. In some embodiments, the cooling assembly rotates into the maintenance position, closing a gap between the cooling assembly and the EPTO pod compared to the gap between the cooling assembly and the EPTO pod in the use position.

In some embodiments, the EPTO pod further includes a frame defining an angled portion relative to the front end of the rear-loading refuse vehicle. When the cooling assembly is in the maintenance position, the cooling assembly is positioned substantially adjacent to the angled portion of the EPTO pod.

In some embodiments, the rear-loading refuse vehicle further includes a step assembly coupled to the chassis on a side thereof. The step assembly is configured for a user to step onto the step assembly to access an interior volume of the cowl assembly. In some embodiments, the EPTO pod is positioned within the interior volume of the cowl assembly on a side of the refuse vehicle opposite the step assembly. In some embodiments, the EPTO pod further includes a frame, where the frame is mounted to a roof of the cab of the rear-loading refuse vehicle, such that a gap is defined between the frame of the EPTO pod and an external surface of the rear-loading body assembly.

Another embodiment relates to a rear-loading refuse vehicle including a chassis, a cab coupled to a front end of the chassis, a rear-loading body assembly coupled to the chassis and positioned behind the cab, where the rear-loading body assembly is configured to receive refuse therein and compact refuse via a packing actuator, an electric energy storage device coupled to the chassis, an electric drive motor coupled to the chassis and electrically connected to the electric energy storage device for driving the rear-loading refuse vehicle, a cowl assembly including a front shroud coupled to the cab and a rear shroud positioned at least partially behind the front shroud, a cooling assembly positioned within the cowl assembly, and an electric power take off (EPTO) pod removably coupled to the cab and positioned within the rear shroud between the cooling assembly and the rear-loading body assembly, with the EPTO pod configured to pump hydraulic fluid to actuate the packing actuator of the rear-loading body assembly.

In some embodiments, the EPTO pod is configured for the cooling assembly to rotate rearward and past a front edge of the EPTO pod from a use position to a maintenance position. In some embodiments, the EPTO pod includes a frame mounted to a roof of the cab, where a gap is defined between the frame of the EPTO pod and an external surface of the rear-loading body assembly. The frame defines an angled portion relative to the front end of the rear-loading refuse vehicle. When the cooling assembly is rotated at least partially within the rear shroud, the cooling assembly is positioned substantially adjacent to the angled portion of the EPTO pod.

Another embodiment relates to a method for assembling a rear-loading refuse vehicle. The method includes coupling a cowl assembly to a cab of the rear-loading refuse vehicle, where the cowl assembly is positioned at least partially above the cab, and where the cowl assembly includes a front shroud coupled to the cab and a rear shroud positioned at least partially behind the front shroud. The rear-loading refuse vehicle includes a chassis, where the cab is coupled to a front end of the chassis, and a rear-loading body assembly coupled to the chassis and positioned behind the cab. The method further includes coupling a cooling assembly to the cab, with the cooling assembly positioned within the front shroud of the cowl assembly, where the cooling assembly is rotatable between a use position and a maintenance position. The method further includes coupling an electric power take off (EPTO) pod to the cab, where the EPTO pod is positioned within the rear shroud of the cowl assembly and between the cab and the rear-loading body assembly, and where the EPTO is configured to operate a packing actuator of the rear-loading body assembly.

In some embodiments, the method further includes assembling the EPTO pod, where the EPTO pod includes a frame defining an angled portion. When the EPTO pod is coupled to the cab, the angled portion is positioned facing at least partially toward the front end of the rear-loading refuse vehicle. In some embodiments, the EPTO pod includes a reservoir of hydraulic fluid, an inverter electrically coupled to an electric energy storage device of the rear-loading refuse vehicle, an electric motor electrically coupled to the inverter, and a pump coupled to the motor and configured to pump hydraulic fluid from the reservoir to the packing actuator. The inverter, the electric motor, and the pump are positioned within the frame of the EPTO pod.

In some embodiments, the method further includes rotating the cooling assembling into the maintenance position, where the cooling assembly is rotated past a front edge of the EPTO pod, such that the cooling assembly is at least partially positioned within the rear shroud. In some embodiments, when the cooling assembly is in the maintenance position, the cooling assembly is positioned substantially adjacent to the angled portion of the EPTO pod.

In some embodiments, coupling the EPTO pod to the cab includes forming a gap between the frame of the EPTO pod and an external surface of the rear-loading body assembly. In some embodiments, the rear-loading body assembly includes, a refuse compartment including a hopper volume and a storage volume, and a packing actuator configured to compact refuse from the hopper volume into the storage volume. In some embodiments, the method further includes coupling an electric energy storage device to the chassis, and coupling an electric drive motor to the chassis, where the electric drive motor is electrically connected to the electric energy storage device for driving the rear-loading refuse vehicle.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1.

FIG. 3 is a perspective view of a refuse vehicle showing a cooling assembly positioned within a cowl assembly.

FIG. 4 is a left section view of the vehicle of FIG. 3.

FIG. 5 is a perspective view of the vehicle of FIG. 3 with some components removed for viewing interior components of the vehicle.

FIG. 6 is a perspective view of a rear-loading refuse vehicle, according to an exemplary embodiment.

FIG. 7 is a top view of the rear-loading refuse vehicle of FIG. 6.

FIGS. 8-10 are perspective section views of the rear-loading refuse vehicle of FIG. 6.

FIG. 11 is a flowchart depicting components of an electric power take-off pod, according to an exemplary embodiment.

FIG. 12 is a diagram of the electric power-take off pod, according to an exemplary embodiment.

FIG. 13 is a flowchart of a method for assembling a rear-loading refuse vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the Figures, various embodiments of an electric rear-loading refuse vehicle are shown. The electrified rear-loading refuse vehicle is configured to enable the use of a rear-loading body assembly (e.g., a hydraulically actuated rear-loading body assembly) for receiving, compacting, and storing refuse. Rear-loading bodies are typically shorter than other types of refuse bodies (e.g., front-loading, side-loading) due, at least in part, to the increased packing density associated with rear-loading configurations. This reduction in length can result in less area for mounting components of electric vehicle systems. The structure of the electric rear-loading refuse vehicles described herein enables use of the shorter chassis design for rear-loading bodies to accommodate the rear-loading body without significantly impacting performance.

In some embodiments, the electric rear-loading refuse vehicles include an electric power take off (EPTO) system to enable the use of a hydraulically actuated rear-loading body. The electric rear-loading refuse vehicles of the present disclosure may be structured to accommodate the EPTO system in a cab mounted arrangement that reduces the overall space claim of the electric-to-hydraulic components along the chassis. Further, the cab mounted EPTO system is structured to enable access to and movement of heat exchangers used to cool the electric and/or hydraulic system components, which are also cab mounted. Embodiments of the electric rear-loading refuse vehicle can maintain operational capabilities of a rear loading refuse vehicle architecture, while increasing refuse collection efficiency, but without substantially increasing the overall vehicle footprint relative to non-electric refuse vehicle designs.

According to an exemplary embodiment, an electric rear-loading refuse vehicle including a chassis extending a longitudinal length of the electric rear-loading refuse vehicle and a cab coupled to a front end of the chassis. The electric rear-loading refuse vehicle further includes a rear-loading body assembly coupled to the chassis and positioned behind the cab. The rear-loading body assembly includes a refuse compartment including a hopper volume and a storage volume, and a packing actuator configured to compact refuse from the hopper volume into the storage volume. The electric rear-loading refuse vehicle further includes an electric energy storage device coupled to the chassis, and an electric drive motor coupled to the chassis and electrically connected to the electric energy storage device for driving the electric rear-loading refuse vehicle. The electric rear-loading refuse vehicle further includes a cowl assembly including a front shroud coupled to the cab and a rear shroud positioned at least partially behind the front shroud, and an electric power take off (EPTO) pod removably coupled to the cab and positioned within the cowl assembly. The EPTO pod includes a reservoir of hydraulic fluid, an inverter electrically coupled to the electric energy storage device, an electric motor electrically coupled to the inverter, and a pump coupled to the motor and configured to pump hydraulic fluid from the reservoir to the packing actuator.

### Overall Vehicle

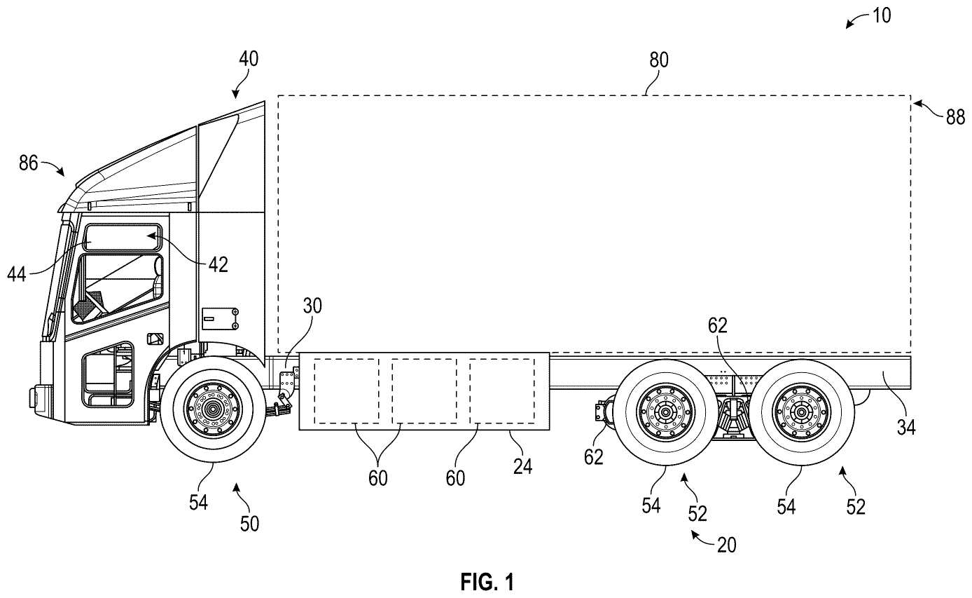

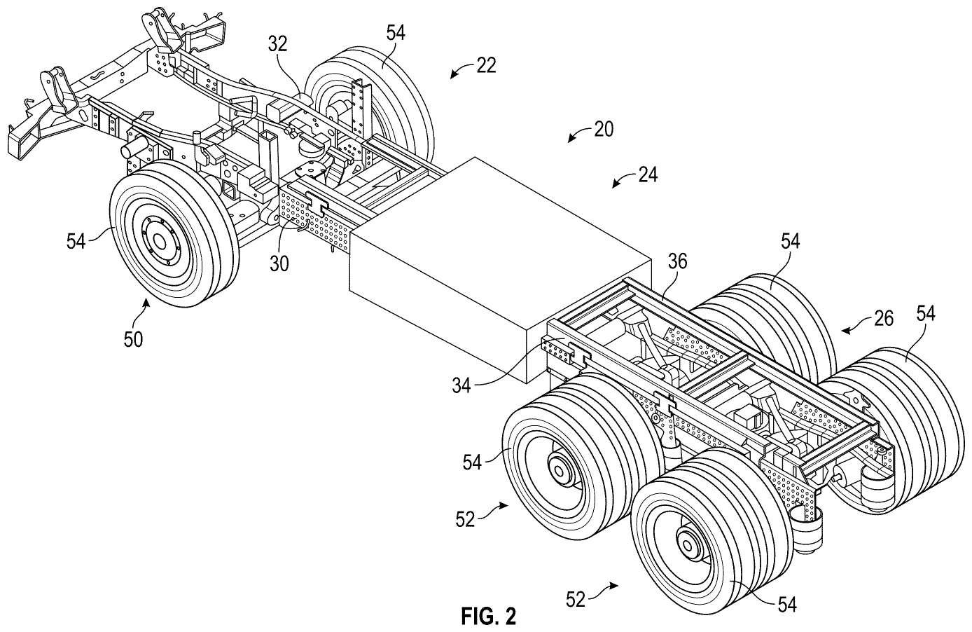

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles 52 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators, electric drive motors), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### A. Electric Power Take-off for Overall Vehicle

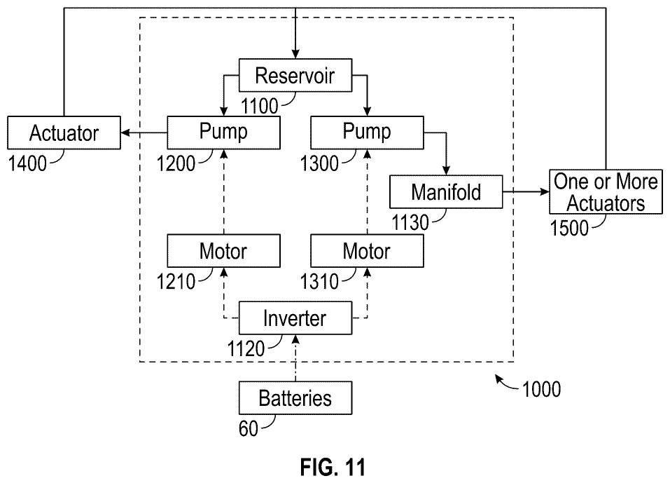

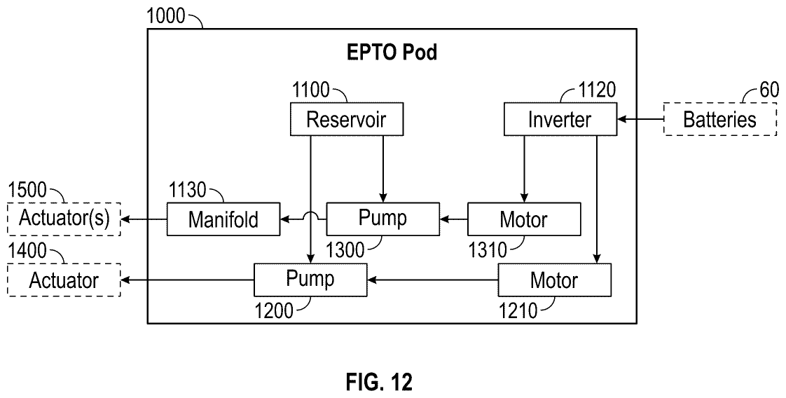

Referring to FIGS. 11 and 12, an electric power take off (EPTO) pod 1000 includes a tank, shown as reservoir 1100, a first pump (e.g., a pack pump, primary pump), shown as pump 1200, a first motor (e.g., pack motor, primary motor), shown as motor 1210, a second pump (e.g., auxiliary pump, secondary pump), shown as pump 1300, a second motor (e.g., an auxiliary pump, secondary pump), shown as motor 1310, an inverter 1120, and a pressure distributer, shown as manifold 1130.

The reservoir 1100 provides a supply of low-pressure (e.g., atmospheric) fluid (e.g., hydraulic fluid). The pump 1200 is fluidly coupled to the reservoir 1100 and draws low pressure fluid from of the reservoir 1100 and supplies the fluid at increased pressure to an actuator 1400 (e.g., a packing actuator). The pump 1200 supplies pressurized (e.g., high pressure) fluid to the actuator 1400 in order to complete one or more functions, such as move the pack panel to compress refuse. The pump 1300 is fluidly coupled to the reservoir 1100 and draws low pressure fluid from the reservoir 1100 and supplies the fluid at increased pressure to the manifold 1130. The manifold 1130 distributes the pressurized fluid by sending the fluid to one or more actuators 1500. The pump 1300 supplies pressurized (e.g., high pressure) fluid to the one or more actuators 1500 in order to operate one or more components and/or complete one or more functions of the refuse vehicle 100.

One or more batteries or a battery pack, shown as batteries 60 (e.g., batteries 60), supply electrical energy to the inverter 1120 in the form of direct current (DC) power. The inverter 1120 converts DC power to alternating current (AC) power, and the inverter 1120 supplies AC power to the motor 1210 and the motor 1310 (i.e., the motor 1210 and the motor 1310 are electric motors). The motor 1210 is mechanically coupled to pump 1200 and is configured to drive the pump 1200 to move low pressure fluid from reservoir 1100 to high pressure in order to operate the actuator 1400. The motor 1310 is mechanically coupled to the pump 1300 and is configured to drive the pump 1300 to move low pressure fluid from reservoir 1100 to high pressure in order to operate the one or more actuators 1500.

In some embodiments, the EPTO pod 1000 includes only one motor. For example, the EPTO pod 1000 may only include pump 1200. The EPTO pod 1000 may only include pump 1300. In some embodiments, the EPTO pod 1000 may only include one actuator hookup. For example, the EPTO pod 1000 may only include the actuator 1400. The EPTO pod 1000 may only include the manifold 1130 for operation of the one or more actuators 1500. The actuator 1400 may be configured within the one or more actuators 1500.

In some embodiments, the EPTO pod 1000 may be positioned along a front portion of the body 80 (e.g., the application kit) of the refuse vehicle 100. In some embodiments, the EPTO pod 1000 is coupled to the front portion of a refuse vehicle 100 in the form of a front-loading refuse vehicle and/or side-loading refuse vehicle. In general, the EPTO pod 1000 is formed as a self-contained sub-assembly that can be assembled offboard a vehicle and attached to the vehicle during the final assembly steps. In some embodiments, the EPTO pod 1000 may be removably coupled to the refuse vehicle 100 by a plurality of fasteners (e.g., screws, bolts, rivets, or other fastening mechanisms).

The batteries 60 supplies electrical energy to the EPTO pod 1000. The batteries 60 stores electrical energy that is sent to the inverter 1120 as direct current (DC). The batteries 60 may be located on the refuse vehicle 100 outside the EPTO pod 1000. In some embodiments, the batteries 60 may be located within the EPTO pod 1000. The inverter 1120 is electrically coupled to the batteries 60 from which the inverter 1120 receives electrical energy in the form of DC power. The inverter 1120 is configured to invert the DC power from the battery to AC power to be sent the motor 1210 and the motor 1310. The inverter 1120 is electrically coupled to the motor 1210 and the motor 1310 such that once the inverter 1120 changes the DC to the AC, the inverter 1120 transmits the AC to the motor 1210 and the motor 1310 to drive the pump 1200 and the pump 1300, respectively. The motor 1210 is electrically coupled to the inverter 1120 and mechanically coupled to the pump 1200 such that the motor 1210 is powered by the AC power from the inverter 1120 and uses the AC power to provide mechanical energy to the pump 1200. The power output of the motor 1210 corresponds to a demanded fluid displacement of the pump 1200. In some embodiments, the motor 1310 is electrically coupled to the inverter 1120 and mechanically coupled to the pump 1300 such that the motor 1310 is powered by the AC power from the inverter 1120 and uses the AC power to provide mechanical energy to the pump 1300. The power output of the motor 1310 corresponds to a demanded fluid displacement of the pump 1300. In some embodiments, the motor 1310 and the motor 1210 are similar and/or identical (e.g., same pump capacity, displacement, flow rate, and/or pressure). In some embodiments, the demanded fluid displacement of the pump 1200 is greater than the demanded fluid displacement of the pump 1300, and the motor 1210 may have a higher power output that corresponds to the power required for the pump 1200 to operate the actuator 1400 (e.g., the packing actuator). The reservoir 1100 stores hydraulic fluid (e.g., oil), and the reservoir 1100 is fluidly coupled to the pump 1200, the pump 1300, the actuator 1400, and the one or more actuators 1500. The manifold 1130 is fluidly coupled to the pump 1300 and receives pressurized fluid from the pump 1300. The manifold 1130 is configured to selectively distribute the pressurized fluid to the one or more actuators 1500. The components of the EPTO pod 1000 may be coupled to the frame of the EPTO pod 1000 and/or surfaces within. The components of the EPTO pod 1000 may be coupled to each other, including as described herein.

### B. Cowl Assembly for Overall Vehicle

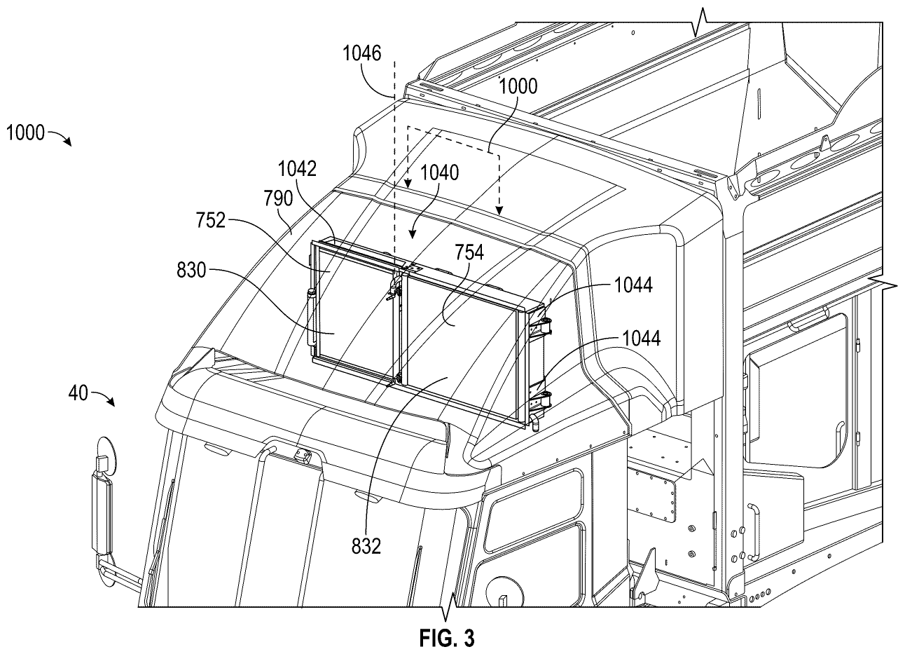

Referring to FIGS. 3 through 5, a vehicle 100 is shown according to an embodiment as described herein. The vehicle 100 may be configured with any of the application kits 80 described herein.

As shown, the vehicle 100 includes a cowl assembly 1010 including a first cowl portion, shown as front shroud 790, and a second cowl portion, shown as rear shroud 792. The front shroud 790 is coupled to the cab 40 and positioned above the cab 40. The rear shroud 792 is coupled to the body 770 of the application kit (e.g., a refuse compartment 130 when the vehicle 100 is configured as a rear-loading refuse vehicle) and extends forward, toward the front shroud 790. A space, volume, or compartment, shown as storage compartment 1012, is defined between the body 770, the cab 40, the rear shroud 792, and the chassis 20. Specifically, the storage compartment 1012 is positioned below the rear shroud 792, above the chassis 20, forward of the body 770, and behind the cab 40. The front shroud 790 and the rear shroud 792 of the cowl assembly 1010 are movable relative to one another. By way of example, if the body 770 is raised, the rear shroud 792 is raised relative to the front shroud 790, which may occur to facilitate access to components within the front shroud 790 (e.g., for cleaning or maintenance).

In some embodiments, the vehicle 100 includes a cooling assembly, shown as core assembly 1040, positioned within a radiator volume 800 (e.g., inner volume, interior volume, etc.) defined by the cowl assembly 1010. Specifically, the core assembly 1040 is positioned between the roof of the cab 40 and the front shroud 790. The core assembly 1040 includes a core 752 and a core 754 each coupled to a subframe, shown as core frame 1042. The core frame 1042 is pivotally coupled to the cab 40 by a pair of couplers, shown as hinges 1044, such that the core assembly 1040 is rotatable relative to the cab 40 about a substantially vertical axis, shown as axis of rotation 1046. In other embodiments, the core frame 1042 is pivotally coupled to the body 770 by the hinges 1044. In such an embodiment, the core assembly 1040 may move relative to the cab 40 as the body 770 moves relative to the cab 40. The core 752 and the core 754 may be fixedly coupled to the core frame 1042, such that the core assembly 1040 moves together as one assembly about the axis of rotation 1046. The axis of rotation 1046 is laterally offset from the center of the vehicle 100 to be positioned near the end of the core assembly 1040. As shown, the axis of rotation 1046 is offset to the left. In other embodiments, the arrangement is mirrored about a longitudinal center plane, such that the axis of rotation 1046 is offset to the right.

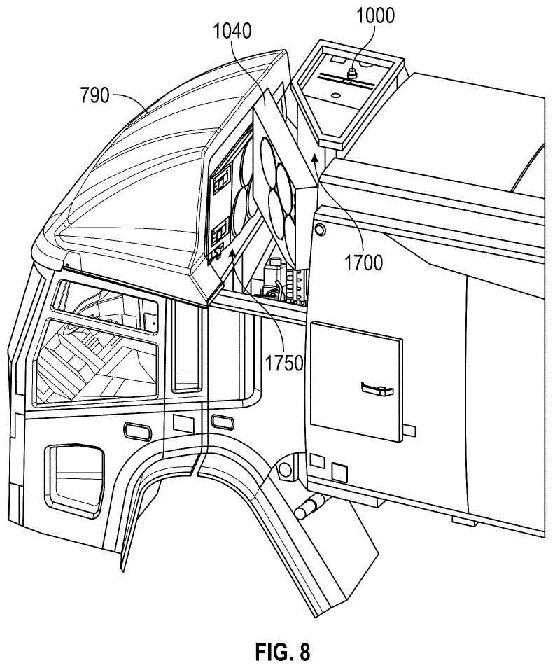

The core assembly 1040 is selectively repositionable about the axis of rotation 1046 between a default position, stored position, or use position, shown in FIG. 3, and an extended position or maintenance position, shown in FIG. 8. The core assembly 1040 may normally remain in the use position (e.g., unless the vehicle 100 is undergoing maintenance). By way of example, the core assembly 1040 may include a latch, fastener, or another type of coupler that selectively limits (e.g., prevents) movement of the core assembly 1040 out of the use position. The core assembly may be released by the coupler and rotated backward toward the maintenance position. The maintenance position may facilitate access by a user (e.g., through the storage compartment 1012) to both the front and rear sides of the core assembly 1040 to facilitate cleaning and/or maintenance. The maintenance position may also facilitate access to the portion of the radiator volume 800 defined between the front shroud 790 and the cab 40.

Referring to FIG. 3, in the use position, the core assembly 1040 extends in a substantially vertical and lateral plane that is substantially perpendicular to a longitudinal axis. Specifically, the plane 830 and the plane 832 extend vertically and laterally and perpendicular to a longitudinal axis. In FIG. 3, the front shroud 790 is shown as being transparent for ease of viewing the core assembly 1040. Referring to FIG. 8, in the maintenance position, the core assembly 1040 rotationally offset about the axis of rotation 1046 (e.g., clockwise as viewed from above) relative to the use position. In the maintenance position, the core assembly 1040 extends rearward, beyond the front shroud 790, such that a space or gap is formed between the core assembly 1040 and the front shroud 790. The core assembly 1040 extends in a substantially vertical plane that is skewed relative to a longitudinal axis. Specifically, the plane 830 and the plane 832 extend vertically and are skewed relative to a longitudinal axis.

In some embodiments, the cowl assembly, including the front shroud and the rear shroud, are a front shroud and a rear shroud as described in U.S. application Ser. No. 18/110,976, filed Feb. 17, 2023, the entire disclosure of which is incorporated by reference herein. Various embodiments of the cowl assembly may be used to achieve advantages such as maximizing storage space (e.g., the radiator volume), optimizing airflow, draining fluid (e.g., rain), and/or providing access for cleaning and/or maintenance (e.g., to the core assembly, to an EPTO).

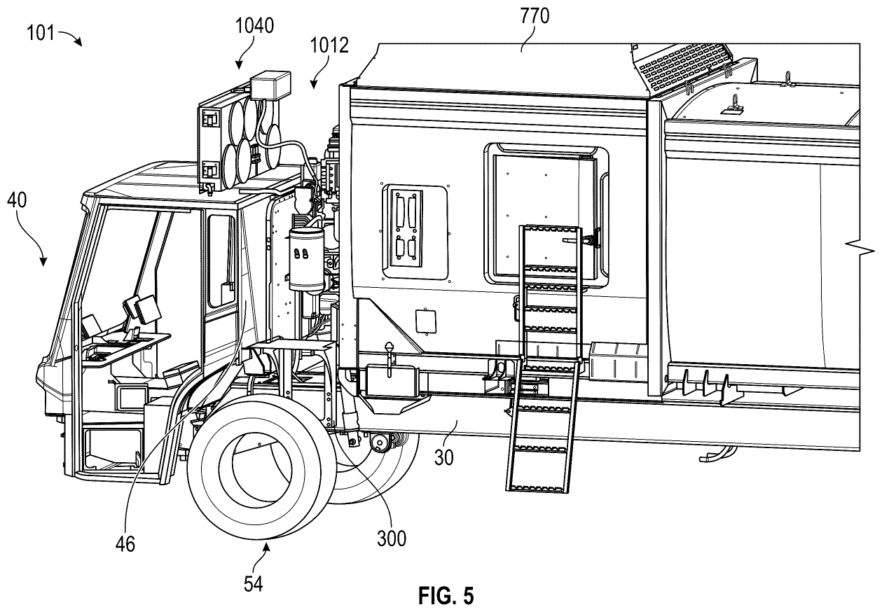

Referring to FIG. 5, to further facilitate user access to the core assembly 1040, the vehicle 100 includes a maintenance step or service step, shown as step assembly 300. The step assembly 300 is coupled to the front rail portion 30 (e.g., fixedly coupled, coupled by one or more fasteners, etc.). As shown, the step assembly 300 is positioned between the rear wall 46 of the cab 40 and the body 770. The step assembly 300 extends above the front rail portion 30 and below the roof of the cab 40. The step assembly 300 extends directly above a wheel and tire assembly 54 of the front axle 50. Accordingly, the step assembly 300 is generally positioned within the storage compartment 1012. Although the step assembly 300 is shown on one side of the vehicle 100 (e.g., a driver side), the step assembly 300 may additionally or alternatively be positioned on the opposite side of the vehicle 100 (e.g., a passenger side). The step assembly 300 includes a step surface or top member (e.g., a top plate). The top plate extends in a generally horizontal plane and provides a surface onto which a user can step. Extending downward from the top plate along the back of the step assembly 300 is an attachment plate or back member (e.g., a back plate). The back plate is configured to be directly coupled to the front rail portion 30 to couple the step assembly 300 to the chassis 20.

A user may stand on the step assembly 300 when accessing the cooling assembly 1040. By way of example, the user may step directly onto the step assembly 300 from the ground. By way of another example, the user may first step onto the wheel and tire assembly 54 and then onto the step assembly 300. By placing the step assembly 300 directly above a wheel and tire assembly 54, the wheel and tire assembly 54 may facilitate the user climbing the vehicle 100 without requiring an additional step.

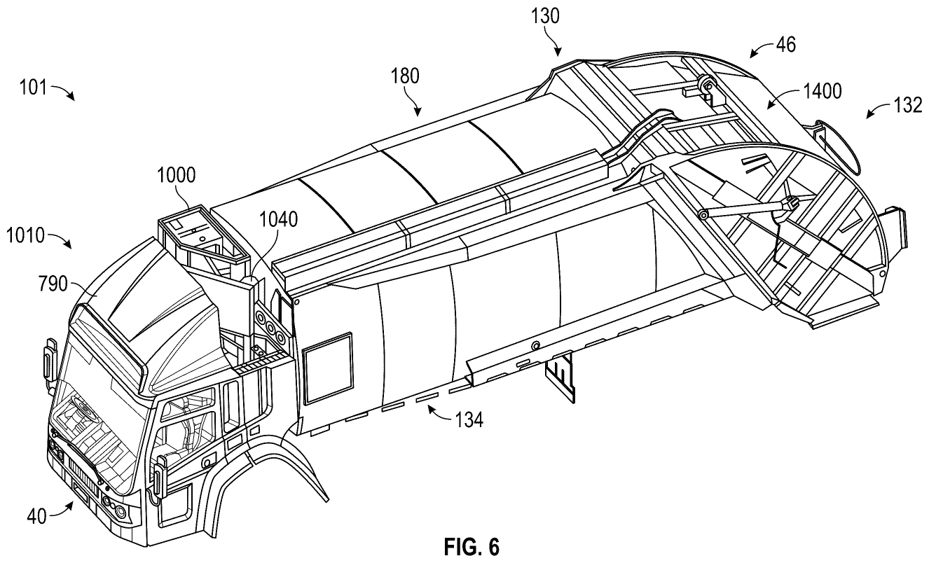

Referring now to FIGS. 1 and 6, the vehicle 10 is configured as a refuse vehicle (e.g., a refuse truck, a garbage truck, a waste collection truck, a sanitation truck, a recycling truck, etc.). Specifically, the refuse vehicle is a rear-loading refuse vehicle. The refuse vehicle may be configured to transport refuse from various waste receptacles (e.g., refuse containers) within a municipality to a storage and/or processing facility (e.g., a landfill, an incineration facility, a recycling facility, etc.).

Still referring to FIGS. 1 and 6, the vehicle 10, shown as electric rear-loading refuse vehicle 101, is configured as an electric vehicle that is propelled by an electric powertrain system. The electric rear-loading refuse vehicle 101 includes a chassis 20 extending a longitudinal length of the vehicle and a cab 40 coupled to a front end of the chassis 20. The chassis 20 and the cab 40 may be configured according to an embodiment as disclosed herein.

Referring to FIGS. 1-2 and 6, the electric rear-loading refuse vehicle 101 further includes one or more electric energy storage devices coupled to the chassis and one or more prime movers coupled to the chassis and electrically connected to the electric energy storage device for driving the electric roll-off vehicle. The one or more electrical energy storage devices (e.g., batteries, capacitors, etc.) are shown as batteries 60. In some embodiments, the batteries 60 are positioned within the middle section 24 of the chassis 20 (see FIG. 2). The one or more prime movers and/or electromagnetic devices (e.g., motor/generators) are shown as drive motors 62. The drive motors 62 are electrically coupled to the batteries 60, where the drive motors 62 are configured to receive electrical energy from the batteries 60 and provide rotational mechanical energy to the wheel and tire assemblies 54 to propel the vehicle 10. The electric rear-loading refuse vehicle 101 further includes the application kit 80 (see FIG. 1) configured as a rear-loading body assembly 180. In some embodiments, the electric rear-loading refuse vehicle 101 further includes the cowl assembly.

The rear-loading body assembly 180 is coupled to the chassis 20. The rear-loading body assembly 180 is positioned behind the cab 40. The rear-loading body assembly 180 rests on the chassis 20 when in use on the electric rear-loading refuse vehicle 101. In some embodiments, the rear-loading body assembly 180 may be coupled to one or more of the front section 22, the middle section 24, or the rear section 26 of the chassis 20. The rear-loading body assembly 180 may be mounted on the frame rails (e.g., the first frame rail, the second frame rail) and/or a frame rail portion (e.g., the front rail portion 30 and the front rail portion 32). The rear-loading body assembly 180 may be mounted on the chassis 20 when the chassis 20 is configured according to an embodiment as described herein.

The rear-loading body assembly 180 of the electric rear-loading refuse vehicle 101 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. As shown, the hopper volume 132 is positioned at a rear end of the electric rear-loading refuse vehicle 101 (e.g., refuse is loaded into a portion of the refuse compartment 130 at the rear end of the vehicle and stored in a portion further toward the cab 40 of the refuse compartment 130). In other words, the storage volume may be positioned between the hopper volume and the cab 40.

The rear-loading body assembly 180 includes a tailgate 34 defines an opening 38 of the hopper volume 132. The rear-loading body assembly 180 also includes a packer system 46 (e.g., a packing assembly, a compaction apparatus, a claw, a hinged member, etc.) that is configured to draw (e.g., move, compact) refuse into the storage volume 134 for storage. For example, the electric rear-loading refuse vehicle 101 is configured for refuse to be loaded into the rear-loading body assembly 180 via the hopper volume 132, where the refuse is then compacted by the packer system 46 into the storage volume 134 for storage of the refuse. The tailgate 34 may be hingedly coupled with the refuse compartment 130 such that the tailgate 34 can be opened or closed (e.g., to collect refuse, during a dumping operation). In some embodiments, the rear-loading body assembly 180 is electrically coupled to the batteries 60 of the electric rear-loading refuse vehicle 101 for operating the rear-loading body assembly 180 to compact refuse. The packer system 64 may be electrically coupled to the batteries 60 of the electric rear-loading refuse vehicle 101.

In some embodiments, the electric rear-loading refuse vehicle 101 may be an all-electric rear-loading refuse vehicle. For example, the components of the electric rear-loading refuse vehicle 101, such as the drive motors 62, actuators of the rear-loading body assembly 180 (e.g., a packing actuator, etc.), etc., may be powered by the batteries 60. In some embodiments, the actuators onboard the electric rear-loading refuse vehicle 101 may be electric actuators. In some embodiments, the actuators may be hydraulic actuators, where a pump for hydraulic fluid is powered by the batteries 60 (e.g., via an electric motor powered thereby, etc.). The electric rear-loading refuse vehicle 101 (e.g., such as an all-electric rear-loading refuse vehicle) may be configured similarly to embodiments of the vehicle 100, as described herein (e.g., components may be positioned, repositioned, and/or uniquely configured for use within the electric rear-loading refuse vehicle 101 similarly to the vehicle 100, as described herein, etc.).

In some embodiments, the rear-loading body assembly 180 is shorter relative to a front-loading body and/or a side-loading body. Embodiments of the vehicle configured with a front-loading body (e.g., a front-loading refuse vehicle) and/or a side-loading body (e.g., a side-loading refuse vehicle) may be described in U.S. application Ser. No. 18/110,976, filed Feb. 17, 2023, the entire disclosure of which is incorporated by reference herein.

In some embodiments, the chassis 20 is configured for a rear body portion of the chassis 20 to have a length corresponding approximately to a longitudinal length of the rear-loading body assembly 180. In some embodiments, the chassis 20 may be longer than the rear-loading body assembly 180, for example, to accommodate coupling to the cab 40. In some embodiments, the chassis 20 and/or the rear body portion of the chassis 20 may be shorter than the rear-loading body assembly 180, for example, if the refuse compartment 130 is configured for the hopper volume 132 to extend past (e.g., hang off) the chassis 20 at the rear end of the electric rear-loading refuse vehicle 101.

In some embodiments, the chassis 20 may be shortened to accommodate the longitudinal length of the rear-loading body assembly 180, thereby shortening the longitudinal length of the vehicle 10, as compared to the chassis 20 of the front-loading refuse vehicle and/or the side-loading refuse vehicle. For example, the frame rails (e.g., the first frame rail, the second frame rail) of the chassis 20 may be shortened to accommodate the rear-loading body assembly 180. In some embodiments, one or more of the front section 22, the middle section 24, or the rear section 26 may be shortened to shorten the chassis 20 (see FIG. 2). For example, one or more of the front rail portion 30, the front rail portion 32, the rear rail portion 34, and the rear rail portion 36. In some embodiments, the front section 22 may be coupled to the rear section 26 of the chassis 10 by the rear-loading body assembly 180, thereby shortening the longitudinal length of the vehicle 10 by decreasing separation between the front section 22 and the rear section 26 of the chassis 20. Other configurations of the chassis 20 as described herein may be shortened and/or otherwise modified to shorten the chassis 20 (e.g., the middle section 26 may be shortened) and the longitudinal length of the vehicle 10.

By loading refuse into the rear-loading body assembly 180, a greater packing density can be achieved. In other words, more refuse can be compacted in the refuse compartment 130 with the rear-loading configuration. Elongating the rear-loading body assembly 180 to fit on the chassis 20 (e.g., the frame rails) of an embodiment of the side-loading refuse vehicle and/or the front-loading refuse vehicle may overload the structural limits of the chassis 20 (e.g., break and/or warp the chassis) due to a weight of refuse compacted within the refuse compartment 130 of the rear-loading body assembly 180 (e.g., since more refuse can be compacted in the rear-loading body assembly as compared to the side-loading body and/or the front-loading body).

In some embodiments, the rear-loading body assembly 180 may include one or more support members. The support members of the rear-loading body assembly 180 may be configured to be mounted on the chassis 20. The support members may be mounted on the frame rails. In some embodiments, the support members may be mounted on the middle section 24 of the chassis 20. The support member being mounted on the middle section 24 of the chassis 20 may displace one or more of the batteries 60 stored in the middle section 24 of the chassis 20. One or more of the batteries 60 may be positioned and/or repositioned in the storage compartment. In some embodiments, the rear-loading body assembly 180 mounted on the chassis 20 maintains a volume of the storage compartment when compared to the vehicle 10 configured as the side-loading refuse vehicle and/or the front-loading refuse vehicle. Components of the electric rear-loading refuse vehicle 101, as described herein, may be positioned, repositioned, and/or uniquely configured for use within the electric rear-loading refuse vehicle 101 to accommodate the chassis 20 configured shorter than the chassis 20 of the side-loading refuse vehicle or the front-loading refuse vehicle, for mounting the rear-loading body assembly 180 onto the chassis 20. For example, an EPTO pod 1000 may not be positioned on the rear-loading body assembly 180 due to a lack of space between the cab 40 and the rear-loading body assembly 180. The EPTO pod 1000 may be positioned within the cowl assembly 1010.

### A. Radiator Volume Configuration for the Rear-loading Refuse Vehicle

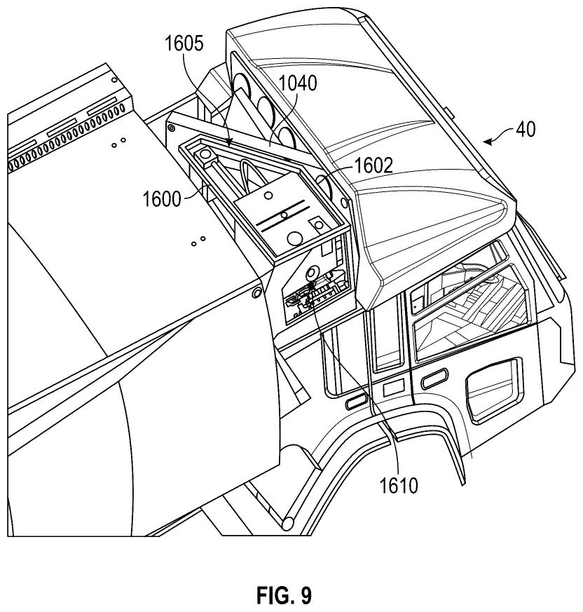

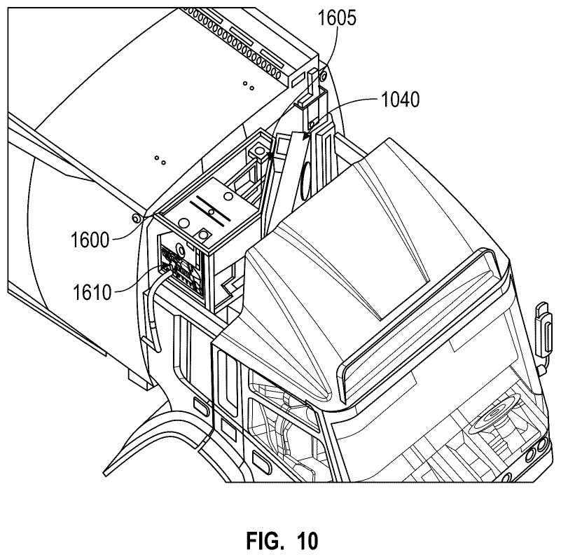

Referring to FIGS. 1, 3, and 7-10, the electric rear-loading refuse vehicle 101 includes the cowl assembly 1010 including the front shroud 790 and the rear shroud 792. The front shroud 790 is coupled to the cab 40 and positioned above the cab 40. The rear shroud 792 is coupled to the rear-loading body assembly 180 (e.g., supported by a front facing wall of the rear-loading body assembly) and extends forward, toward the front shroud 790. The storage compartment 1012 may be defined below the rear shroud 792, above the chassis 20, forward of the rear-loading body assembly 180, and behind the cab 40. The front shroud 790 and the rear shroud 792 of the cowl assembly 1010 are movable relative to one another. For example, the rear shroud 792 may be moved and/or removed to facilitate access to components within the front shroud 790 (e.g., for cleaning or maintenance).

The electric rear-loading refuse vehicle 101 includes the cooling assembly 1040 positioned within the radiator volume 800 defined by the cowl assembly 1010. The cooling assembly 1040 may be positioned between the roof of the cab 40 and the front shroud 790. The cooling assembly 1040 is configured to cool components (e.g., pumps, electrical, motors) of the electric rear-loading refuse vehicle 101. The cooling assembly 1040 may be configured according to an embodiment as described herein. In some embodiments, the cooling assembly 1040 may also be configured to cool the EPTO pod 1000 and/or components thereof (e.g., pump 1200, motor 1210). Positioning the EPTO pod 1000 and the cooling assembly 1040 within the radiator volume 800 of the cowl assembly 1010 can increase the cooling efficiency of the electric rear-loading refuse vehicle 101 and/or components thereof.

Referring to FIGS. 6 through 10, the electric rear-loading refuse vehicle 101 includes an electric power take-off (EPTO) pod 1000, which can enable the use of a hydraulically-actuated rear-load body assembly with the electrified chassis. The EPTO pod 1000 may include the components of the EPTO pod 1000, as described herein regarding the overall vehicle. The EPTO pod 1000 may be electrically coupled to the batteries 60 of the electric rear-loading refuse vehicle 101. The EPTO pod 1000 is configured to operate the packer system 46 of the rear-loading body assembly 180.

With reference to FIGS. 11 and 12, the electric power take-off (EPTO) pod 1000 includes a tank, shown as reservoir 1100, a first pump (e.g., a pack pump, primary pump), shown as pump 1200, a first motor (e.g., pack motor, primary motor), shown as motor 1210, and an inverter 1120. The EPTO pod 1000 is configured to operate and/or control an actuator 1400. In some embodiments, the EPTO pod 1000 may be configured for the pump 1200 and the motor 1210 to operate and/or control one or more actuators 1500. The actuator 1400 may be configured within the one or more actuators 1500. The EPTO pod 1000 may include a pressure distributer, shown as manifold 1130, for controlling the actuators. In some embodiments, such as the embodiment depicted by FIG. 11, the EPTO pod 1000 further includes a second pump (e.g., auxiliary pump, secondary pump), shown as pump 1300, a second motor (e.g., an auxiliary pump, secondary pump), shown as motor 1310, and the manifold 1130. The manifold 1130 connects to the one or more actuators 1500 in order to operate one or more components and/or complete one or more functions of the electric rear-loading refuse vehicle 101.

The reservoir 1100 provides a supply of low-pressure (e.g., atmospheric) fluid (e.g., hydraulic fluid). The pump 1200 is fluidly coupled to the reservoir 1100 and draws low pressure fluid from of the reservoir 1100 and supplies the fluid at increased pressure to an actuator 1400 (e.g., a packing actuator). The pump 1200 supplies pressurized (e.g., high pressure) fluid to the actuator 1400 in order to complete one or more functions, such as move the packer system 46 to compress refuse. The EPTO pod 1000 may operate similarly for using the pump 1300 and motor 1310, as described herein. In other words, the EPTO pod 1000 is an electrical to hydraulic interface of the electric rear-loading refuse vehicle 101, where electrical energy from the batteries 60 is converted into hydraulic energy using the EPTO pod 1000 (e.g., electrical energy powers the motor 1210 to convert the electrical energy into hydraulic energy using the pump 1200 and fluid from the fluid reservoir 1100).

Referring now to FIGS. 6-10, the EPTO pod 1000 is positioned within the radiator volume 800 of the cowl assembly 1010. The EPTO pod 1000 may be fixed within the radiator volume 800. The EPTO pod 1000 is coupled to the cab 40. In some embodiments, the EPTO pod 1000 may be coupled to the roof of the cab 40. The EPTO pod 1000 may be coupled to the cab 40 and positioned within the radiator volume 800 of the cowl assembly 1010 underneath the rear shroud 792. In some embodiments, the EPTO pod 1000 may be positioned within the radiator volume 800 on a side of the electric rear-loading refuse vehicle 101 opposite the step assembly 300 (see FIG. 5). In some embodiments, the EPTO pod 1000 may be coupled to the rear-loading body assembly 180 (e.g., by the front facing wall of the rear-loading body assembly 180). The EPTO pod 1000 may be positioned within the radiator volume 800 of the cowl assembly 1010 underneath the rear shroud 792.

In some embodiments, the EPTO pod 1000 includes a frame 1600 of the EPTO pod 1000. The frame 1600 may include one or more support members configured to define a volume 1610 of the EPTO pod 1000 where the components (e.g., pump 1200, motor 1210) of the EPTO pod 1000 are positioned. In some embodiments, the frame 1600 of the EPTO pod 1000 includes an angled portion 1605 (e.g., relative to the front end of the vehicle 10, etc.). The angled portion 1605 may be positioned at least partially facing frontward (e.g., toward the front end of the electric rear-loading refuse vehicle 101). The angled portion 1605 may be facing inward (e.g., into the radiator volume 800 of the cowl assembly 1010). The angled portion 1605 may be configured for the EPTO pod 1000 to be positioned within the cowl assembly 1010 where the cooling assembly 1040 is also positioned within the cowl assembly 1010.

The EPTO pod 1000 is contained within the rear shroud 792. For example, the frame 1600 of the EPTO pod 1000 may be approximately a height of the rear shroud 792 (e.g., the height underneath the rear shroud 792). The frame 1600 of the EPTO pod 1000 may be approximately a length of the rear shroud 792. In other words, the frame 1600 is configured to fit below the rear shroud 792, above the cab 40, and in front of the rear-loading body assembly 180. The volume 1610 of the EPTO pod 1000 is also configured to fit underneath the rear shroud 792. For example, the volume 1610 of the EPTO pod 1000 is configured to fit underneath the rear shroud 792, above the cab 40, and in front of the rear-loading body assembly 180. In some embodiments, a gap is defined between the frame 1600 of the EPTO pod 1000 and an external surface (e.g., facing the front end of the vehicle 10, etc.) of the rear-loading body assembly 180.

In some embodiments, the components of the EPTO pod 1000 may be coupled to the frame 1600 (e.g., to the one or more support members) of the EPTO pod 1000 and/or surfaces within. The components of the EPTO pod 1000 may be coupled to each other, including as described herein. In some embodiments, the EPTO pod 1000 is formed as a self-contained sub-assembly that can be assembled offboard the electric rear-loading refuse vehicle 101 and attached to the electric rear-loading refuse vehicle 101 during the final assembly steps. For example, the EPTO pod 1000 may be removably coupled to the electric rear-loading refuse vehicle 101 by a plurality of fasteners (e.g., screws, bolts, rivets, or other fastening mechanisms). The plurality of fasteners may couple the frame 1600 of the EPTO pod 1000 to the cab 40.

In some embodiments, the batteries 60 supply electrical energy to the EPTO pod 1000 (e.g., the EPTO pod 1000 is electrically coupled to the batteries 60). The batteries 60 store electrical energy that is sent to the inverter 1120 as direct current (DC). The batteries 60 may be located on the refuse vehicle 100 outside the EPTO pod 1000. In some embodiments, the batteries 60 may be located within the EPTO pod 1000. The inverter 1120 is electrically coupled to the batteries 60 from which the inverter 1120 receives electrical energy in the form of DC power. The inverter 1120 is configured to invert the DC power from the battery to AC power to be sent the motor 1210. The inverter 1120 is electrically coupled to the motor 1210 and/or the motor 1310 such that once the inverter 1120 changes the DC to the AC, the inverter 1120 transmits the AC to the motor 1210 to drive the pump 1200. The motor 1210 is electrically coupled to the inverter 1120 and mechanically coupled to the pump 1200 such that the motor 1210 is powered by the AC power from the inverter 1120 and uses the AC power to provide mechanical energy to the pump 1200. The power output of the motor 1210 corresponds to a demanded fluid displacement of the pump 1200.

In some embodiments, the pump 1300 and the motor 1310 are operated similarly to the pump 1200 and the motor 1210, as described herein. In some embodiments, the motor 1310 and the motor 1210 are similar and/or identical (e.g., same pump capacity, displacement, flow rate, and/or pressure). In some embodiments, the demanded fluid displacement of the pump 1200 is greater than the demanded fluid displacement of the pump 1300, and the motor 1210 may have a higher power output that corresponds to the power required for the pump 1200 to operate the actuator 1400 (e.g., the packing actuator). The reservoir 1100 stores hydraulic fluid (e.g., oil), and the reservoir 1100 is fluidly coupled to the pump 1200, the pump 1300, the actuator 1400, and the one or more actuators 1500. The manifold 1130 is fluidly coupled to the pump 1300 and receives pressurized fluid from the pump 1300. The manifold 1130 is configured to selectively distribute the pressurized fluid to the one or more actuators 1500.

Referring to FIG. 6, the actuator 1400 is located within the hopper volume 132 of the refuse compartment 130, where the actuator 1400 may include one or more packing actuators configured to compact refuse into the storage volume 134. The EPTO pod 1000 may be coupled to the packer system 46 of the rear-loading body assembly 180. For example, the electric rear-loading refuse vehicle 101 is configured for refuse to be loaded into the rear-loading body assembly 180 via the hopper volume 132, where the refuse is then compacted by the packer system 46, using the one or more packing actuators hydraulicly powered by the EPTO pod 1000, into the storage volume 134 for storage of the refuse onboard the electric rear-loading refuse vehicle 101. With more refuse placed in the refuse compartment 130, the actuator 1400 will require a greater force to move the compactor and compact the refuse. As the greater force is required, the pump 1200 will displace the hydraulic fluid at a faster rate and/or a higher pressure in order to activate the actuator 1400 to compact the refuse. The packing actuator may be configured similarly to the pack panel as described in U.S. patent application Ser. No. 18/342,603, which is commonly-owned and incorporated herein by reference in its entirety.

Referring to FIGS. 6-10, the EPTO pod 1000 and the cooling assembly 1040 are both positioned within the cowl assembly 1010. The EPTO pod 1000 may be structured to allow the cooling assembly 1040 to rotate and/or pivot into the maintenance position, without impedance by the EPTO pod 1000. For example, the frame 1600 of the EPTO pod 1000 may be shaped corresponding to a rotation of the cooling assembly 1040 so there is clearance between the EPTO pod 1000 and the cooling assembly 1040 when moving the cooling assembly 1040. For example, the angled portion 1605 of the frame 1600 of the EPTO pod 1000 may be positioned facing the front end of the electric rear-loading refuse vehicle 101 (e.g., toward the front shroud 790). The cooling assembly 1040 may rotate into the maintenance position, where the cooling assembly 1040 is rotated to a position adjacent to (e.g., substantially parallel to, etc.) the angled portion 1605 of the frame 1600 of the EPTO pod 1000. For example, the cooling assembly 1040 may rotate past a front edge 1602 (e.g., an edge substantially facing the front end of the vehicle 10, etc.) of the frame 1600 of the EPTO pod 1000 (e.g., when rotated into the maintenance position, etc.). In the use position, the cooling assembly 1040 may be positioned forward of the front edge 1602 of the EPTO pod 1000 (e.g., in the front shroud 790, etc.). The angled portion 1605 of the frame 1600 of the EPTO pod 1000 may allow the cooling assembly 1040 to be rotated far enough for access to components of the cooling assembly 1040 (e.g., on a front of the vehicle facing side of the cooling assembly 1040) and/or for access to the portion of the radiator volume 800 located underneath the front shroud 790. In some embodiments, the cooling assembly 1040 may not rotate parallel to the angled portion 1605 of the frame 1600 of the EPTO pod 1000. The cooling assembly 1040 may be configured to limit rotation before reaching parallel to the angled portion 1605 of the frame 1600 of the EPTO pod 1000.

Referring to FIG. 8, in the maintenance position, the cooling assembly 1040 is rotationally offset about the axis of rotation 1046 (e.g., counterclockwise as viewed from above) relative to the use position. In some embodiments, the cooling assembly 1040 is rotatable relative to the cab 40 (e.g., using hinges 1044) about a substantially vertical axis, shown as axis of rotation 1046. For example, the axis of rotation 1046 may be positioned for the cooling assembly 1040 to rotate toward the EPTO pod 1000. The axis of rotation 1046 may be positioned adjacent to the EPTO pod 1000.

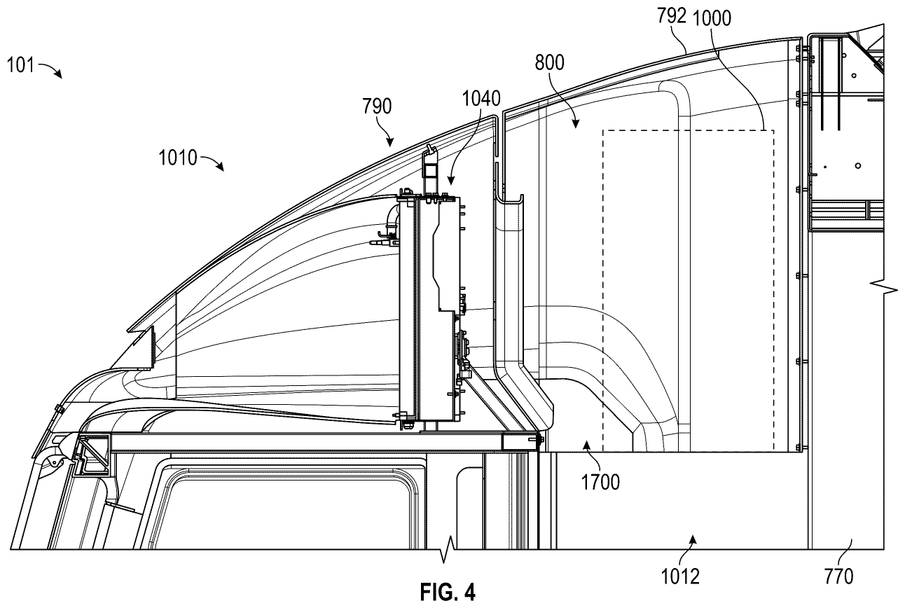

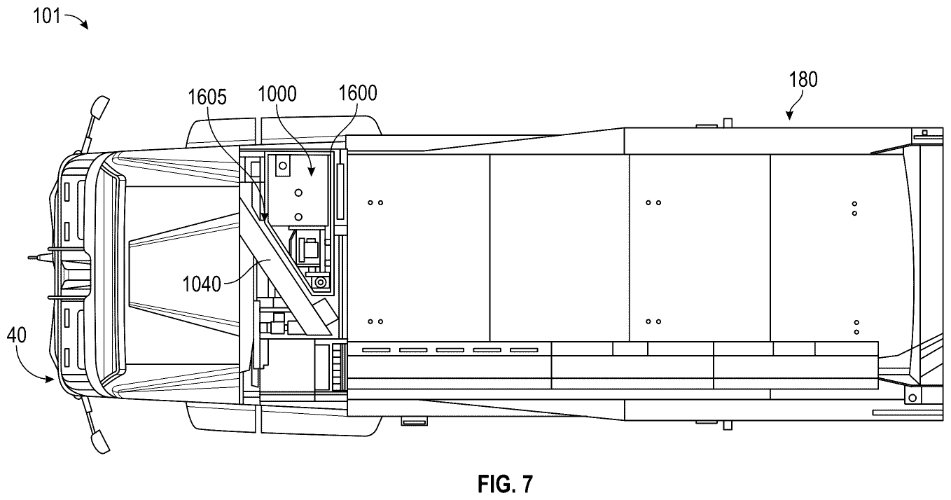

When the cooling assembly 1040 is in the use position, the cooling assembly 1040 is positioned within the front shroud 790. The EPTO pod 1000 is positioned within the rear shroud 792, with a space or gap 1700 formed between the cooling assembly 1040 and the EPTO pod 1000 (e.g., the angled portion 1605 thereof, etc.). In the maintenance position, the cooling assembly 1040 extends rearward beyond the front shroud 790, closing the space or gap 1700 between the cooling assembly 1040 and the EPTO pod 1000, when compared to the space or gap 1700 in the use position (see FIGS. 4 and 7). In the maintenance position, the cooling assembly 1040 extending rearward beyond the front shroud 790 to close the space or gap 1700 and create a space or gap 1750 between the cooling assembly 1040 and the front shroud 790. The space or gap 1750 between the cooling assembly 1040 and the front shroud 790 may be used for cleaning and/or maintenance of the cooling assembly 1040 (e.g., to access the front-facing side of the cooling assembly 1040) and/or to access the portion of the radiator volume 800 underneath the front shroud 790 (e.g., to clean and/or perform maintenance).

### B. Method of Assembly for Rear-loading Refuse Vehicle With EPTO Pod

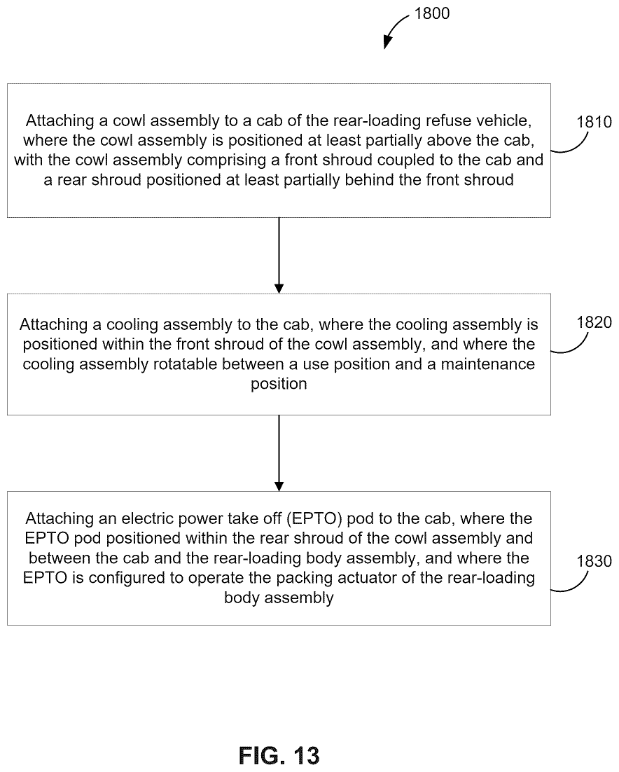

Referring to FIG. 13, a method 1800 for assembling a rear-loading refuse vehicle is depicted. For example, the method 1800 may be completed (e.g., carried out, implemented, etc.) to assembly an embodiment of the vehicle 100, as described herein. In some embodiments, the method 1800 may include additional, fewer, and/or a different order of method steps (e.g., operation).

The method 1800 includes attaching (e.g., coupling, connected, etc.) a cowl assembly to a cab of the rear-loading refuse vehicle, where the cowl assembly is positioned at least partially above the cab, with the cowl assembly comprising a front shroud coupled to the cab and a rear shroud positioned at least partially behind the front shroud, at 1810. For example, the cowl assembly may be an embodiment of the cowl assembly 1010, as described herein. In some embodiments, the rear-loading refuse vehicle may include a chassis, where the cab is coupled to a front end of the chassis. A rear-loading body assembly may be coupled to the chassis rearward of the cab (e.g., rear-loading body assembly 180, etc.). For example, the rear-loading body assembly may be configured to receive refuse, where a packing actuator compacts the refuse for storage within the rear-loading body assembly (e.g., to increase the pack density of refuse, thereby increasing the amount of refuse stored therein, etc.).

The method 1800 may include attaching a cooling assembly to the cab, where the cooling assembly is positioned within the front shroud of the cowl assembly, and where the cooling assembly rotatable between a use position and a maintenance position, at 1820. For example, the cooling assembly may be an embodiment of the cooling assembly 1040, as described herein. The cooling assembly may be positioned within the front shroud when in the use position, where the cooling assembly is rotatable to be at least partially positioned within the rear shroud when in the maintenance position.

The method 1800 may include attaching an electric power take off (EPTO) pod to the cab, where the EPTO pod positioned within the rear shroud of the cowl assembly and between the cab and the rear-loading body assembly, and where the EPTO is configured to operate the packing actuator of the rear-loading body assembly, at 1830. For example, the EPTO pod may be an embodiment of the EPTO pod 1000, as described herein. Attaching the EPTO pod to the cab may include forming a gap between the frame of the EPTO pod and an external surface of the rear-loading body assembly (e.g., the EPTO pod may not be coupled to the rear-loading body assembly, as the chassis supporting the rear-loading body assembly may be shorted compared to chassis for other types of body assemblies, thereby reducing the space on the rear-loading body assembly for the EPTO pod behind the cab, etc.).

In some embodiments, the method 1800 may include assembling the EPTO pod (e.g., attaching a reservoir storing hydraulic fluid, an inverter, an electric motor, a pump, etc.). In some embodiments, the EPTO pod may be pre-assembly before attaching the EPTO pod to the rear-loading refuse vehicle (e.g., the components of the EPTO pod may be assembled to form said EPTO pod, etc.). For example, in some embodiments, the EPTO pod may include a frame (e.g., storing the components of the EPTO pod therein, etc.) The frame may define an angled portion, such that when the EPTO pod is coupled to the cab, the angled portion is positioned facing at least partially toward the front end of the rear-loading refuse vehicle. The frame may include a front edge (e.g., an edge positioned toward the front end of the rear-loading refuse vehicle, an edge facing the front end of the rear-loading refuse vehicle, etc.). In some embodiments, the method 1800 may include rotating the cooling assembling into the maintenance position, where the cooling assembly is rotated past the front edge of the EPTO pod, such that the cooling assembly is at least partially positioned within the rear shroud. When the cooling assembly is in the maintenance position, the cooling assembly is positioned substantially adjacent to the angled portion of the EPTO pod. Thereby, the EPTO pod and the cooling assembly may both be mounted to the rear-loading refuse vehicle within the cowl assembly, while providing access to the cooling assembly by rotating said cooling assembly (e.g., since the cooling assembly is positioned in front of the EPTO pod, etc.). Providing the EPTO pod to operate the packing actuator and/or other actuators of the rear-loading body assembly provides for the rear-loading refuse vehicle to be an electric rear-loading refuse vehicle (e.g., where operation of the vehicle is completed via electric energy, etc.).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A rear-loading refuse vehicle comprising:
a chassis;
a cab coupled to a front end of the chassis;
a rear-loading body assembly coupled to the chassis and positioned behind the cab, the rear-loading body assembly comprising:
a refuse compartment comprising a hopper volume and a storage volume; and
a packing actuator configured to compact refuse from the hopper volume into the storage volume;
an electric energy storage device coupled to the chassis;
an electric drive motor coupled to the chassis and electrically connected to the electric energy storage device for driving the rear-loading refuse vehicle;
a cowl assembly comprising a front shroud coupled to the cab and a rear shroud positioned at least partially behind the front shroud; and
an electric power take off (EPTO) pod removably coupled to the cab and positioned within the rear shroud between the cab and the rear-loading body assembly, the EPTO pod comprising:
a reservoir of hydraulic fluid;
an inverter electrically coupled to the electric energy storage device;
an electric motor electrically coupled to the inverter; and
a pump coupled to the motor and configured to pump hydraulic fluid from the reservoir to the packing actuator.

2. The rear-loading refuse vehicle of claim 1, wherein the EPTO pod is coupled to a roof of the cab and positioned within the rear shroud.

3. The rear-loading refuse vehicle of claim 1 further comprising a cooling assembly positioned within the cowl assembly.

4. The rear-loading refuse vehicle of claim 3, wherein the EPTO pod is configured for the cooling assembly to rotate rearward and past a front edge of the EPTO pod from a use position to a maintenance position.

5. The rear-loading refuse vehicle of claim 4, wherein the cooling assembly rotates into the maintenance position, closing a gap between the cooling assembly and the EPTO pod compared to the gap between the cooling assembly and the EPTO pod in the use position.

6. The rear-loading refuse vehicle of claim 4, wherein the EPTO pod further comprises a frame defining an angled portion relative to the front end of the rear-loading refuse vehicle, and where when the cooling assembly is in the maintenance position, the cooling assembly is positioned substantially adjacent to the angled portion of the EPTO pod.

7. The rear-loading refuse vehicle of claim 1, further comprising a step assembly coupled to the chassis on a side thereof, the step assembly configured for a user to step onto the step assembly to access an interior volume of the cowl assembly.

8. The rear-loading refuse vehicle of claim 7, wherein the EPTO pod is positioned within the interior volume of the cowl assembly on a side of the refuse vehicle opposite the step assembly.

9. The rear-loading refuse vehicle of claim 1, wherein the EPTO pod further comprises a frame, the frame mounted to a roof of the cab of the rear-loading refuse vehicle, wherein a gap is defined between the frame of the EPTO pod and an external surface of the rear-loading body assembly.

10. A rear-loading refuse vehicle comprising:
a chassis;
a cab coupled to a front end of the chassis;
a rear-loading body assembly coupled to the chassis and positioned behind the cab, wherein the rear-loading body assembly is configured to receive refuse therein and compact refuse via a packing actuator;
an electric energy storage device coupled to the chassis;
an electric drive motor coupled to the chassis and electrically connected to the electric energy storage device for driving the rear-loading refuse vehicle;
a cowl assembly comprising a front shroud coupled to the cab and a rear shroud positioned at least partially behind the front shroud;
a cooling assembly positioned within the cowl assembly; and
an electric power take off (EPTO) pod removably coupled to the cab and positioned within the rear shroud between the cooling assembly and the rear-loading body assembly, the EPTO pod configured to pump hydraulic fluid to actuate the packing actuator of the rear-loading body assembly.

11. The rear-loading refuse vehicle of claim 10, wherein the EPTO pod is configured for the cooling assembly to rotate rearward and past a front edge of the EPTO pod from a use position to a maintenance position.

12. The rear-loading refuse vehicle of claim 10, wherein the EPTO pod further comprises a frame mounted to a roof of the cab, wherein a gap is defined between the frame of the EPTO pod and an external surface of the rear-loading body assembly, and wherein the frame defines an angled portion relative to the front end of the rear-loading refuse vehicle, and when the cooling assembly is rotated at least partially within the rear shroud, the cooling assembly is positioned substantially adjacent to the angled portion of the EPTO pod.

13. A method for assembling a rear-loading refuse vehicle, the method comprising:
coupling a cowl assembly to a cab of the rear-loading refuse vehicle, the cowl assembly positioned at least partially above the cab, wherein the cowl assembly comprises a front shroud coupled to the cab and a rear shroud positioned at least partially behind the front shroud, and wherein the rear-loading refuse vehicle comprises:
a chassis, wherein the cab is coupled to a front end of the chassis; and
a rear-loading body assembly coupled to the chassis and positioned behind the cab;
coupling a cooling assembly to the cab, the cooling assembly positioned within the front shroud of the cowl assembly, wherein the cooling assembly rotatable between a use position and a maintenance position; and
coupling an electric power take off (EPTO) pod to the cab, the EPTO pod positioned within the rear shroud of the cowl assembly and between the cab and the rear-loading body assembly, wherein the EPTO is configured to operate a packing actuator of the rear-loading body assembly.

14. The method of claim 13, further comprising assembling the EPTO pod, wherein the EPTO pod comprises a frame defining an angled portion, wherein when the EPTO pod is coupled to the cab, the angled portion is positioned facing at least partially toward the front end of the rear-loading refuse vehicle.

15. The method of claim 14, wherein the EPTO pod comprises:
a reservoir of hydraulic fluid;
an inverter electrically coupled to an electric energy storage device of the rear-loading refuse vehicle;
an electric motor electrically coupled to the inverter; and
a pump coupled to the motor and configured to pump hydraulic fluid from the reservoir to the packing actuator;
wherein the reservoir, the inverter, the electric motor, and the pump are positioned within the frame of the EPTO pod.

16. The method of claim 13, further comprising rotating the cooling assembling into the maintenance position, wherein the cooling assembly is rotated past a front edge of the EPTO pod, such that the cooling assembly is at least partially positioned within the rear shroud.

17. The method of claim 14, wherein when the cooling assembly is in the maintenance position, the cooling assembly is positioned substantially adjacent to the angled portion of the EPTO pod.

18. The method of claim 14, wherein coupling the EPTO pod to the cab comprises forming a gap between the frame of the EPTO pod and an external surface of the rear-loading body assembly.

19. The method of claim 13, wherein the rear-loading body assembly comprises:
a refuse compartment comprising a hopper volume and a storage volume; and
a packing actuator configured to compact refuse from the hopper volume into the storage volume.

20. The method of claim 13, further comprising:
coupling an electric energy storage device to the chassis; and
coupling an electric drive motor to the chassis, the electric drive motor electrically connected to the electric energy storage device for driving the rear-loading refuse vehicle.
